(19) United States
(12) Patent Application Publication
(10) Pub. No.: US 2025/0367863 A1
(43) Pub. Date: Dec. 4, 2025

(54) Apparatus for and Method of Forming a Shopping Basket Body with Interchangeable Side Panels

(71) Applicant: Supercart South Africa (Pty) Ltd., Durban (ZA)

(72) Inventor: Michael Castledine Wolfe, Riverside, CA (US)

(21) Appl. No.: 18/950,917

(22) Filed: Nov. 18, 2024

(30) Foreign Application Priority Data
May 28, 2024 (AU) 2024203539

(51) Int. Cl. B29C 45/26; B29C 45/37; B29L 31/00

(52) U.S. Cl. CPC B29C 45/2673; B29C 45/2602; B29C 45/2628; B29C 45/374; B29C 2045/2677; B29L 2031/713

(57) ABSTRACT

An apparatus for forming a plastic shopping basket body is provided, the basket body comprising at least three side walls. The apparatus comprises a plurality of mould sides, one per side wall of the basket body, each mould side including a form insert panel to mould the relevant side wall with customer-specific formations and/or apertures, the form insert panels being (readily) interchangeable to enable a plurality of basket bodies to be moulded with different customer-specific formations and/or apertures, for a plurality of different customers. In an embodiment, the customer-specific formations include branding and/or logos, and the customer-specific apertures include the shape, configuration and pattern of apertures defined in the walls of the basket body that is specific or specifically assigned to a particular customer. The basket bodies may be moulded in different colours, so as to further distinguish the basket bodies of and between different customers.

### FIELD OF THE INVENTION

THIS INVENTION relates to an apparatus for a related method of forming a plastic shopping basket body, for either a shopping trolley or a shopping handbasket, with interchangeable side panels.

The aim of the present invention is to allow a shopping basket body to be customised for a particular retailer in an efficient and cost-effective manner, thereby differentiating a basket body (and thus the related shopping trolley or handbasket) of one retailer from that of another retailer. The customisation typically relates to the colour of the basket body, the use of a retailer-specific branding and logo on the basket body, and even the shape, configuration and pattern of apertures defined in the walls of the basket body. The result is to provide and ensure exclusivity for a particular retailer, with a combination of the retailer's branding/logo and related colour assisting in reducing trolley and handbasket theft.

### SUMMARY OF THE INVENTION

At a high level, the present invention discloses an apparatus for and related method of forming a plastic shopping basket body, for either a shopping trolley or a shopping handbasket, with interchangeable side panels.

According to a first aspect of the invention there is provided an apparatus for forming a plastic shopping basket body, the basket body comprising at least three side walls, the apparatus comprising a plurality of mould sides, one per side wall of the basket body, each mould side including a form insert panel to mould the relevant side wall with customer-specific formations and/or apertures, the form insert panels being (readily) interchangeable to enable a plurality of basket bodies to be moulded with different customer-specific formations and/or apertures, for a plurality of different customers.

In an embodiment, the customer-specific formations include branding and/or logos, and the customer-specific apertures include the shape, configuration and pattern of apertures defined in the walls of the basket body that is specific or specifically assigned to a particular customer. The basket bodies may be moulded in different colours, so as to further distinguish the basket bodies of and between different customers.

In an embodiment, the apparatus includes a base mould to define the base of the basket body, the base mould including an interchangeable form insert panel to mould the base of the basket body, which may also include customer-specific formations and/or apertures.

In an embodiment, the apparatus includes an inner core, with a mould cavity being defined between the inner core and the inner surfaces of the plurality of mould sides and the base mould, into which molten plastic may be injected to form the basket body.

In one version, the basket body is for a shopping trolley, comprising a first side wall, a second, opposite side wall, a front wall and a base. Accordingly, the apparatus comprises first, second and third mould sides, to mould the first side wall, the second, opposite side wall, and the front wall, respectively.

In this version, the first, second and third mould sides are movable relative to each other, with the apparatus including a sliding mechanism to move the first, second and third mould sides from an opened, inoperative configuration to a closed, operative configuration in which the first, second and third mould sides form a unitary arrangement, in conjunction with the base mould, to enable a unitary shopping trolley basket body to be moulded.

In another version, the basket body is for a shopping handbasket (or a smaller version of a basket trolley for a shopping trolley for use by children) comprising four side walls and a base. In this version, the apparatus comprises four static mould sides, which, in conjunction with the base mould, enables a unitary shopping handbasket basket body to be moulded. In another version, the apparatus comprises four movable mould sides, with a sliding mechanism being provided to move the four mould sides from an opened, inoperative configuration to a closed, operative configuration in which the four mould sides form a unitary arrangement, in conjunction with the base mould, to enable a unitary shopping handbasket basket body to be moulded.

According to a second aspect of the invention there is provided a method of forming a plastic shopping basket body, the basket body comprising at least three side walls, the method comprising:
providing a plurality of mould sides, one per side wall of the basket body;
fitting a form insert panel to each mould side, the form insert panel comprising or defining customer-specific formations and/or apertures;
moulding the relevant side wall with customer-specific formations and/or apertures; and
interchanging the form insert panels to enable a plurality of basket bodies to be moulded with different customer-specific formations and/or apertures, for a plurality of different customers.

In an embodiment, the customer-specific formations include branding and/or logos, and the customer-specific apertures include the shape, configuration and pattern of apertures defined in the walls of the basket body that is specific or specifically assigned to a particular customer. The method includes moulding the basket bodies in different colours, so as to further distinguish the basket bodies of and between different customers.

In an embodiment, the method includes providing a base mould to define the base of the basket body, and fitting a form insert panel to the base mould to mould the base of the basket so as to also include customer-specific formations and/or apertures.

In an embodiment, the moulding step includes the step of providing an inner core, with a mould cavity being defined between the inner core and the inner surfaces of the plurality of mould sides and the base mould, and injecting molten plastic into the mould cavity to form the basket body.

In one version, the basket body is for a shopping trolley, comprising a first side wall, a second, opposite side wall, a front wall and a base. Accordingly, the method comprises providing first, second and third mould sides, to mould the first side wall, the second, opposite side wall, and the front wall, respectively.

In this version, the method includes moving the first, second and third mould sides relative to each other, including moving the first, second and third mould sides from an opened, inoperative configuration to a closed, operative configuration in which the first, second and third mould sides form a unitary arrangement, in conjunction with the base mould, to enable a unitary shopping trolley basket body to be moulded.

In another version, the basket body is for a shopping handbasket comprising four side walls and a base. In this version, the method includes providing four static mould sides, which, in conjunction with the base mould, enables a unitary shopping handbasket basket body to be moulded. In another version, the method includes moving the four mould sides from an opened, inoperative configuration to a closed, operative configuration in which the four mould sides form a unitary arrangement, in conjunction with the base mould, to enable a unitary shopping handbasket basket body to be moulded.

### BRIEF DESCRIPTION OF THE DRAWINGS

FIG. 1 shows an exploded perspective view of an apparatus for forming a plastic shopping basket body for a trolley, the trolley comprising a first side wall, a second, opposite side wall and a front wall, the apparatus in turn comprising first, second and third mould sides, to mould the first side wall, the second, opposite side wall, and the front wall, respectively.

FIG. 2 shows a side view of the first mould side, as used by the apparatus shown in FIG. 1, to form a left side of the trolley basket body;

FIG. 3 shows a perspective view of the first mould side shown in FIG. 2;

FIG. 4 shows a side view of the second mould side, as used by the apparatus shown in FIG. 1, to form a right side of the trolley basket body;

FIG. 5 shows a perspective view of the second mould side shown in FIG. 4;

FIG. 6 shows an end view of the third mould side, as used by the apparatus shown in FIG. 1, to form an end wall of the trolley basket body;

FIG. 7 shows a perspective view of the third mould side shown in FIG. 6;

FIG. 8 shows a perspective view of the apparatus shown in FIG. 1, in a closed, operative configuration;

FIG. 9 shows a left top perspective view of the apparatus for forming a plastic shopping basket body for a trolley, this figure showing additional components of the apparatus;

FIG. 10 shows a right top perspective view of the apparatus shown in FIG. 9;

FIG. 11 shows a perspective view of an apparatus for forming a plastic shopping basket body for a handbasket; and

FIG. 12 shows a schematic flowchart of a method of forming a plastic shopping basket body, according to a further aspect of the invention.

### DETAILED DESCRIPTION OF THE INVENTION

The following description of the invention is provided as an enabling teaching of the invention. Those skilled in the relevant art will recognize that many changes can be made to the embodiment described, while still attaining the beneficial results of the present invention. It will also be apparent that some of the desired benefits of the present invention can be attained by selecting some of the features of the present invention without utilizing other features. Accordingly, those skilled in the art will recognize that modifications and adaptations to the present invention are possible and can even be desirable in certain circumstances and are a part of the present invention. Thus, the following description is provided as illustrative of the principles of the present invention and not a limitation thereof.

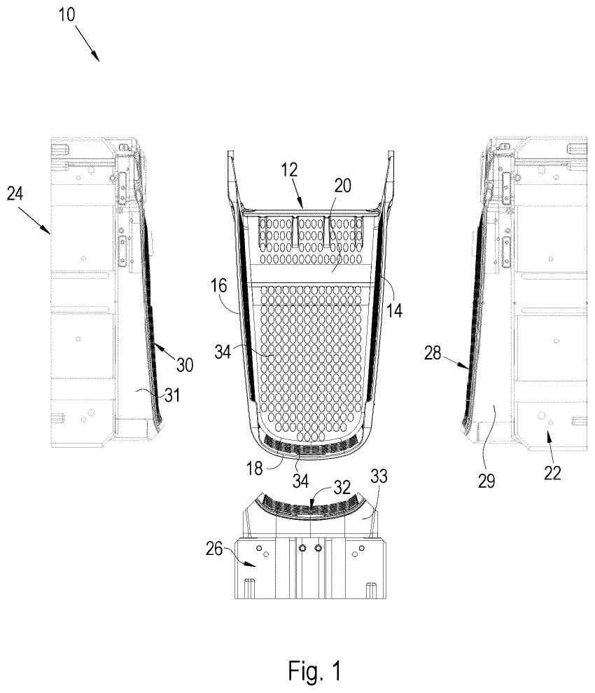

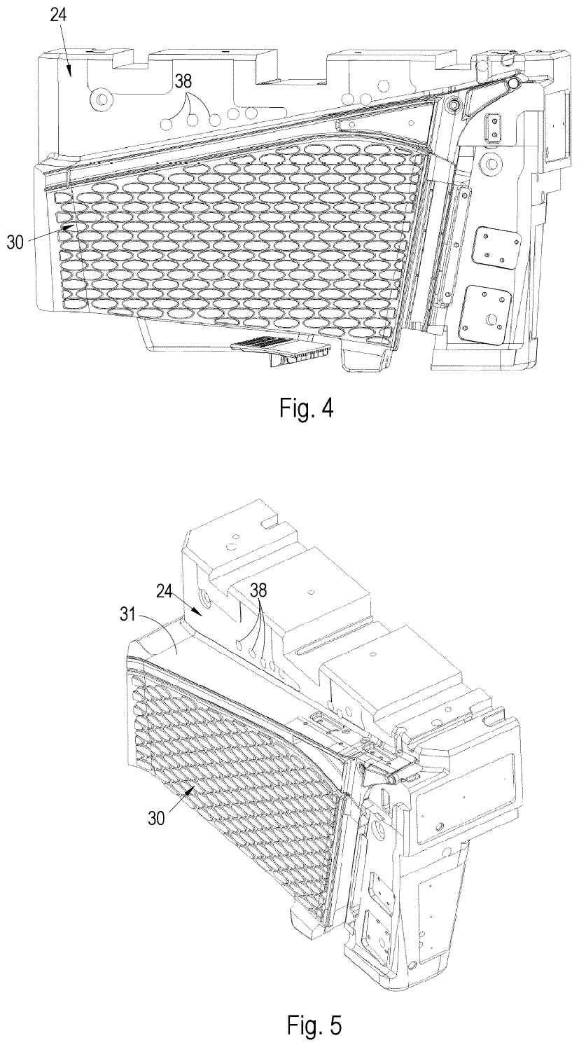

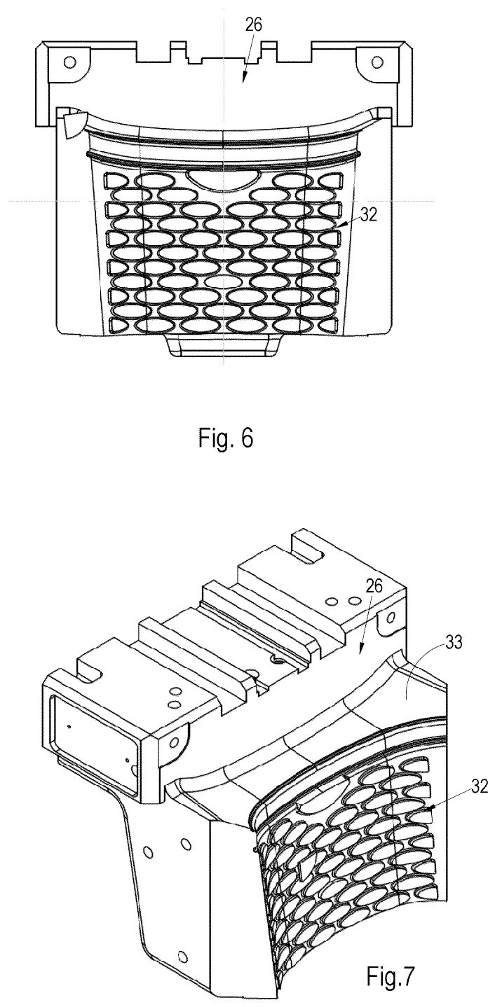

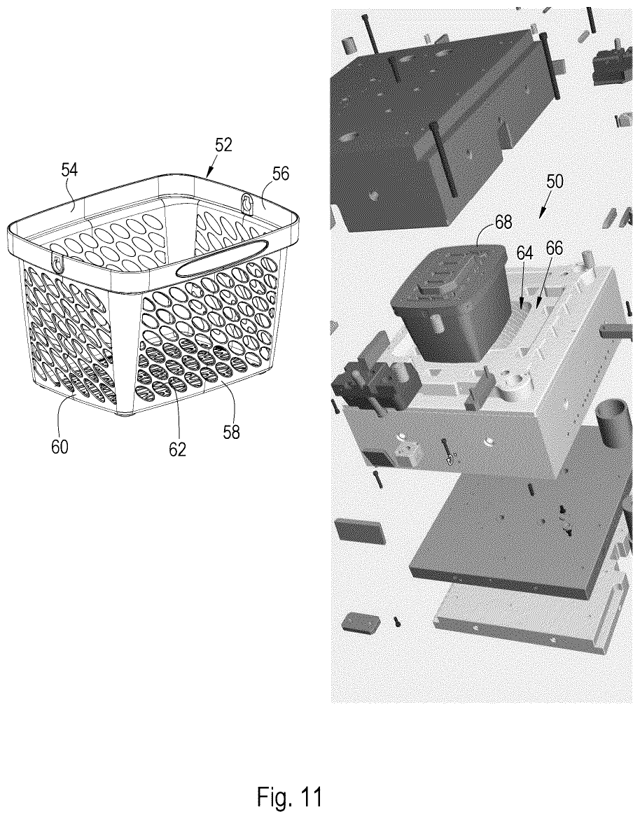

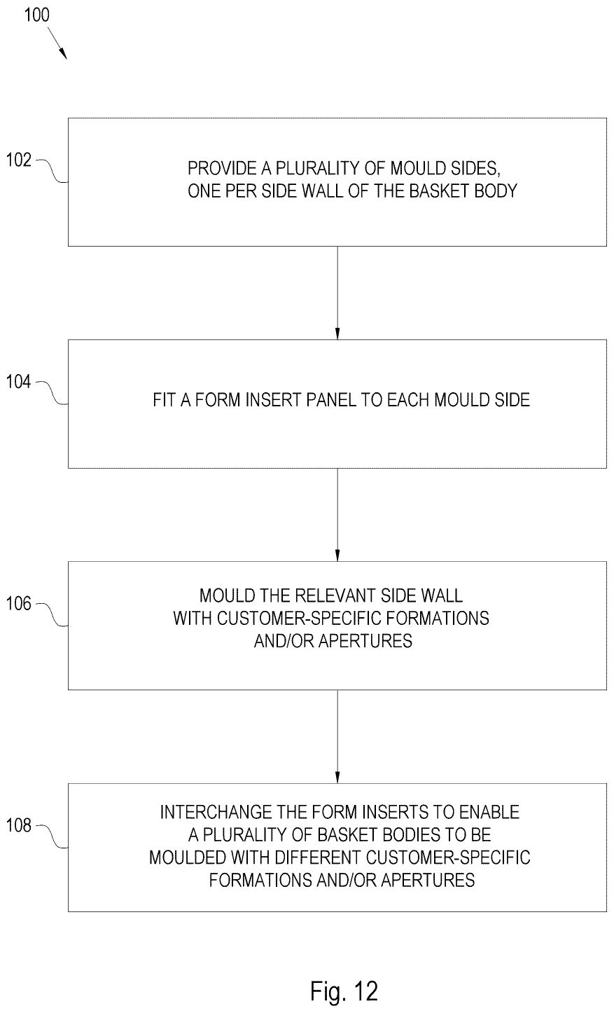

At a high level, the present invention discloses an apparatus 10, 50 for and related method 100 of forming a plastic shopping basket body 12, 52, for either a shopping trolley or a shopping handbasket, with interchangeable side panels. FIGS. 1 to 10 show the apparatus 10 in respect of a plastic shopping basket body 12 for a shopping trolley; FIG. 11 shows the apparatus 50 in respect of a plastic shopping basket body 12 for a shopping handbasket 52 (or a smaller version of a basket trolley for a shopping trolley for use by children); and FIG. 11 show the related method 100 in more detail.

Referring first to FIGS. 1 to 10, there is provided an apparatus 10 for forming a plastic shopping basket body 12 for a shopping trolley, the basket body 12 comprising three side walls, namely a first left side wall 14, a second, opposite right side wall 16, a front wall 18 and a base 20.

The apparatus 10 in turn comprises a plurality of mould sides 22, 24 and 26, one per side wall 14, 16, 18), respectively, of the basket body 12. Each mould side 22, 24 and 26 includes a form insert panel 28, 30, 32, respectively, fitted to an adjacent body 29, 31, 33, respectively, to mould the side walls 16, 18, 20, respectively. The form insert panels 28, 30, 32 include customer-specific formations and/or apertures, with the form insert panels 28, 30, 32 being readily interchangeable (i.e. removable from and then securable to the bodies 29, 31, 33) to enable a plurality of basket bodies 12 to be moulded with different customer-specific formations and/or apertures, for a plurality of different customers. The interchangeable form insert panels 28, 30, 32 thus allow aesthetic differentiation between different customers, in an efficient and cost-effective manner.

Although not shown, the apparatus 10 includes a base mould to define the base 20 of the basket body 12. The base mould also includes an interchangeable form insert panel to mould the base 20 of the basket body 12, which may also include customer-specific formations and/or apertures.

In an embodiment, the customer-specific formations include branding and/or logos, and the customer-specific apertures include the shape, configuration and pattern of apertures 34 defined in the walls 14, 16, 18 and/or the base 20 of the basket body 12 that is specific or specifically assigned to a particular customer. The basket bodies 12 may be moulded in different colours, so as to further distinguish the basket bodies 12 of and between different customers.

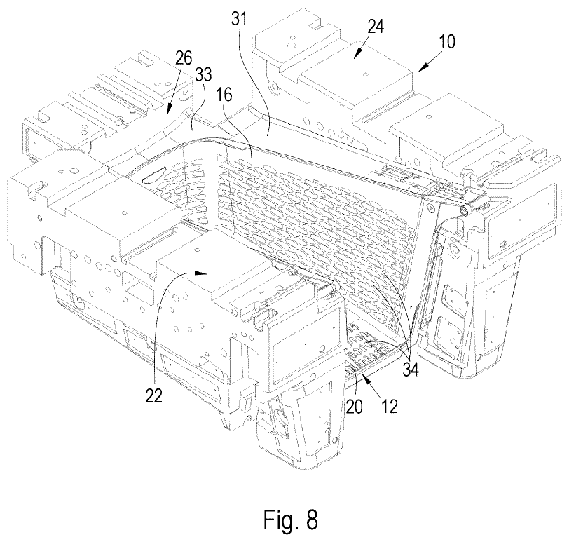

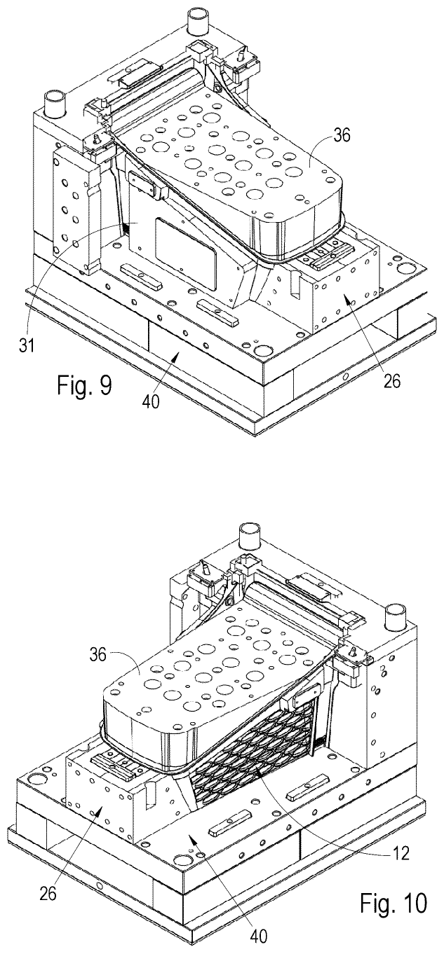

In this version, as best indicated schematically in FIG. 1, the first, second and third mould sides 22, 24 and 26 are movable relative to each other, with the apparatus 10 including a sliding mechanism (not shown) to slidingly move the first, second and third mould sides 22, 24 and 26 from an opened, inoperative configuration, as shown in FIG. 1, to a closed, operative configuration, as shown in FIG. 8, in which the first, second and third mould sides 22, 24 and 26 form a unitary arrangement, in conjunction with the base mould (not shown), to enable a unitary shopping trolley basket body 12 to be moulded. The sliding mechanism is configured to ensure precise alignment, thereby ensuring that the mould sides 22, 24 and 26 and related inner core 36 (shown in FIGS. 9 and 10), and which will be described in more detail further below) come together accurately, maintaining a consistent cavity shape and size.

As indicated above, the apparatus 10 includes an inner core 36, with a mould cavity being defined between the outer surface of the inner core 36; the outer, inwardly facing surfaces of the form insert panels 28, 30, 32 of the mould sides 22, 24 and 26; and the outer, upwardly facing surface of the base mould (not shown). As part of the moulding process, molten plastic may be injected into the mould cavity to form the basket body 12.

The inner core 36 is thus positioned within a space created by the three mould sides 22, 24 and 26 and the base mould, as best shown in FIGS. 9 and 10, with the inner core 36 forming the interior surface of the basket body 12, ensuring the proper shape and structural integrity of the basket body 12. In use, when the mould sides 22, 24 and 26 close around the inner core 36, as shown in FIGS. 9 and 10, they collectively define the mould cavity (in conjunction with the base mould). The cavity's shape corresponds to the outer shape of the basket body 12. The form insert panels 28, 30, 32 on the inner surfaces of the mould sides 22, 24 and 26 define the required customer-specific formations and/or apertures 34. During an injection phase, molten plastic is injected into the mould cavity through an injection nozzle. The plastic fills the space between the inner surfaces of the form insert panels 28, 30, 32 of the mould sides 22, 24 and 26 and the outer surface of the inner core 36. During a subsequent cooling and solidification phase, the plastic cools and solidifies within the mould cavity.

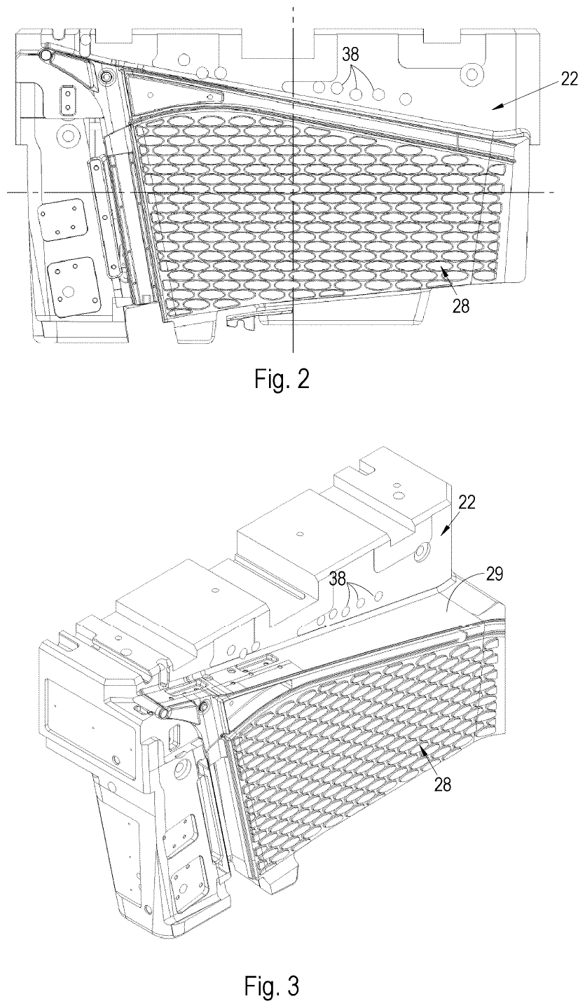

Cooling channels 38 (shown in FIGS. 2 to 5) in the mould sides 22, 24 and 26 and in the inner core ensure 36 ensure efficient heat dissipation and uniform cooling. Thereafter, in an ejection phase, once the plastic has solidified, the mould sides 22, 24 and 26 may be separated with an ejector system to push the moulded basket body 12 off the inner core 36 and out of the mould.

Other components of an injection moulding machine that uses the moulding apparatus 10 include (with reference to FIGS. 9 and 10):
1. Base Frame and Support Structure 40, to provide stability and support the entire moulding apparatus 10, and to provide a framework that houses and aligns the mould sides 22, 24 and 26 accurately.
2. Injection Unit, to melt and inject the plastic material into the mould cavity; to ensure the plastic is melted to the appropriate consistency; and to deliver the molten plastic into the mould cavity.
3. Clamping Unit, to hold the mould sides 22, 24 and 26 together under high pressure during the injection process to ensure the plastic forms correctly.
4. The injection moulding machine provides the force necessary to open and close the mould, ensuring it stays tightly sealed during injection.
5. Cooling System, including the cooling channels 38 which are built into the mould sides 22, 24 and 26 to circulate coolant (usually water) to rapidly cool and solidify the plastic.
6. Temperature Control: Regulates the cooling process to prevent warping or defects in the moulded basket.
7. Ejection System, to push the finished basket body 12 out of the mould once it has solidified and the mould opens.
8. Control System, to manages and automate the entire moulding process, including injection, clamping, cooling, and ejection.

Turning now to FIG. 11, there is provided an apparatus 50 for forming a plastic shopping basket body 52 for a shopping handbasket (or a smaller version of a basket trolley for a shopping trolley for use by children), the basket body 52 comprising four side walls 54, 56, 58 and 60, and a base 62. In this version, the apparatus 52 comprises four static mould sides 64 within the cavity body 66, which, in conjunction with a base mould also within the cavity body 66, and an inner core 68, enables the unitary shopping handbasket basket body 52 to be moulded. In another version, the apparatus 52 comprises four slidably movable mould sides, with a sliding mechanism being provided to move the four mould sides from an opened, inoperative configuration to a closed, operative configuration in which the four mould sides form a unitary arrangement, in conjunction with the base mould, to enable a unitary shopping handbasket basket body to be moulded.

Tuning now to FIG. 11, a method 100 of forming a plastic shopping basket body is shown, the basket body comprising at least three side walls. At a high level, the method 100 comprises the steps of providing a plurality of mould sides, one per side wall of the basket body, as indicated by block 102. The method 100 further includes the step of fitting a form insert panel to each mould side, as indicated by block 104, the form insert panel comprising or defining customer-specific formations and/or apertures.

The method 100 further includes the step of moulding the relevant side wall with customer-specific formations and/or apertures; and, as indicated by block 106.

The method 100 concludes by interchanging the form insert panels to enable a plurality of basket bodies to be moulded with different customer-specific formations and/or apertures, for a plurality of different customers, as indicated by block 108.

In an embodiment, the customer-specific formations include branding and/or logos, and the customer-specific apertures include the shape, configuration and pattern of apertures defined in the walls of the basket body that is specific or specifically assigned to a particular customer. The method includes moulding the basket bodies in different colours, so as to further distinguish the basket bodies of and between different customers.

In an embodiment, the method includes providing a base mould to define the base of the basket body. In one version, the same base is used for each version of the basket body. In another version, the method includes fitting a form insert panel to the base mould to mould the base of the basket so as to also include customer-specific formations and/or apertures (if required).

In an embodiment, the moulding step includes the step of providing an inner core, with a mould cavity being defined between the inner core and the inner surfaces of the plurality of mould sides and the base mould, and injecting molten plastic into the mould cavity to form the basket body.

In one version, the basket body is for a shopping trolley, comprising a first side wall, a second, opposite side wall, a front wall and a base. Accordingly, the method comprises providing first, second and third mould sides, to mould the first side wall, the second, opposite side wall, and the front wall, respectively.

In this version, the method includes moving the first, second and third mould sides relative to each other, including moving the first, second and third mould sides from an opened, inoperative configuration to a closed, operative configuration in which the first, second and third mould sides form a unitary arrangement, in conjunction with the base mould, to enable a unitary shopping trolley basket body to be moulded.

In another version, the basket body is for a shopping handbasket (or a smaller version of a basket trolley for a shopping trolley for use by children) comprising four side walls and a base. In this version, the method includes providing four static mould sides, which, in conjunction with the base mould, enables a unitary shopping handbasket basket body to be moulded. In another version, the method includes moving the four mould sides from an opened, inoperative configuration to a closed, operative configuration in which the four mould sides form a unitary arrangement, in conjunction with the base mould, to enable a unitary shopping handbasket basket body to be moulded.

The present invention has several advantages. The primary advantage is customisation, in that the interchangeable form insert panels on the mould sides enable the relatively easy and efficient formation of customer-specific formations and/or apertures, without extensive retooling.

1. An apparatus for forming a plastic shopping basket body, the basket body comprising at least three side walls, the apparatus comprising a plurality of mould sides, one per side wall of the basket body, each mould side including a form insert panel to mould the relevant side wall with customer-specific formations and/or apertures, the form insert panels being readily interchangeable to enable a plurality of basket bodies to be moulded with different customer-specific formations and/or apertures, for a plurality of different customers.

2. The apparatus of claim 1, wherein the customer-specific formations include branding and/or logos, and the customer-specific apertures include the shape, configuration and pattern of apertures defined in the walls of the basket body that is specific or specifically assigned to a particular customer.

3. The apparatus of either claim 1 or claim 2, wherein the apparatus includes a base mould to define the base of the basket body, the base mould including an interchangeable form insert panel to mould the base of the basket body, which may also include customer-specific formations and/or apertures.

4. The apparatus of claim 3, wherein the apparatus includes an inner core, with a mould cavity being defined between the inner core and the inner surfaces of the plurality of mould sides and the base mould, into which molten plastic may be injected to form the basket body.

5. The apparatus of claim 4, wherein the basket body is for a shopping trolley, comprising a first side wall, a second, opposite side wall, a front wall and a base, with the apparatus comprising first, second and third mould sides, to mould the first side wall, the second, opposite side wall, and the front wall, respectively.

6. The apparatus of claim 5, wherein the first, second and third mould sides are movable relative to each other, with the apparatus including a sliding mechanism to move the first, second and third mould sides between an opened, inoperative configuration to a closed, operative configuration in which the first, second and third mould sides form a unitary arrangement, in conjunction with the base mould, to enable a unitary shopping trolley basket body to be moulded.

7. The apparatus of claim 4, wherein the basket body is for a shopping handbasket comprising four side walls and a base, with the apparatus comprising four static mould sides, which, in conjunction with the base mould, enables a unitary shopping handbasket basket body to be moulded.

8. The apparatus of claim 7, wherein the apparatus comprises four movable mould sides, with a sliding mechanism being provided to move the four mould sides from an opened, inoperative configuration to a closed, operative configuration in which the four mould sides form a unitary arrangement, in conjunction with the base mould, to enable a unitary shopping handbasket basket body to be moulded.

9. A method of forming a plastic shopping basket body, the basket body comprising at least three side walls, the method comprising:
providing a plurality of mould sides, one per side wall of the basket body;
fitting a form insert panel to each mould side, the form insert panel comprising or defining customer-specific formations and/or apertures;
moulding the relevant side wall with customer-specific formations and/or apertures; and
interchanging the form insert panels to enable a plurality of basket bodies to be moulded with different customer-specific formations and/or apertures, for a plurality of different customers.

10. The method of claim 9, wherein the customer-specific formations include branding and/or logos, and the customer-specific apertures include the shape, configuration and pattern of apertures defined in the walls of the basket body that is specific or specifically assigned to a particular customer.

11. The method of either claim 9 or claim 10, wherein the method includes providing a base mould to define the base of the basket body, and fitting a form insert panel to the base mould to mould the base of the basket so as to also include customer-specific formations and/or apertures.

12. The method of claim 11, wherein the moulding step includes the step of providing an inner core, with a mould cavity being defined between the inner core and the inner surfaces of the plurality of mould sides and the base mould, and injecting molten plastic into the mould cavity to form the basket body.

13. The method of claim 12, wherein the basket body is for a shopping trolley comprising a first side wall, a second, opposite side wall, a front wall and a base, with the method comprising providing first, second and third mould sides, to mould the first side wall, the second, opposite side wall, and the front wall, respectively.

14. The method of claim 13, wherein the method includes moving the first, second and third mould sides relative to each other, including moving the first, second and third mould sides from an opened, inoperative configuration to a closed, operative configuration in which the first, second and third mould sides form a unitary arrangement, in conjunction with the base mould, to enable a unitary shopping trolley basket body to be moulded.

15. The method of claim 12, wherein the basket body is for a shopping handbasket comprising four side walls and a base. In this version, the method includes providing four static mould sides, which, in conjunction with the base mould, enables a unitary shopping handbasket basket body to be moulded.

16. The method of claim 15, wherein the method includes moving the four mould sides from an opened, inoperative configuration to a closed, operative configuration in which the four mould sides form a unitary arrangement, in conjunction with the base mould, to enable a unitary shopping handbasket basket body to be moulded.
